(19) United States
(12) Patent Application Publication
(10) Pub. No.: US 2024/0405463 A1
(43) Pub. Date: Dec. 5, 2024

(54) CONNECTOR AND ELECTRONIC DEVICE INCLUDING SAME

(71) Applicant: SAMSUNG ELECTRONICS CO., LTD., Suwon-si (KR)

(72) Inventors: Hanseok MUN, Suwon-si (KR); Waneui JUNG, Suwon-si (KR); Jaeryong HAN, Suwon-si (KR)

(73) Assignee: SAMSUNG ELECTRONICS CO., LTD., Suwon-si (KR)

(21) Appl. No.: 18/797,977

(22) Filed: Aug. 8, 2024

Related U.S. Application Data
(63) Continuation of application No. PCT/KR2023/000643, filed on Jan. 13, 2023.

(30) Foreign Application Priority Data
Feb. 11, 2022 (KR) 10-2022-0018231
Jun. 14, 2022 (KR) 10-2022-0072399

(51) Int. Cl. H01R 12/77; G04G 17/06

(52) U.S. Cl. CPC H01R 12/774; G04G 17/06

(57) ABSTRACT

An electronic device including: a flexible printed circuit board (FPCB) contact electrically connected to a first electronic component; and a receptacle electrically connected to a second electronic component and to which the FPCB contact is detachably connected, where the receptacle includes: a base including a first face facing a first direction, a second face facing a second direction away from the first direction, and a side face including one side face and another side face perpendicularly facing the first and second directions, respectively; a support member fixed to the side face, facing the first face, and configured to support a locking state of the FPCB contact; at least one first node fixed to one side of the base, exposed on the first face, and connected to a first portion of the FPCB contact; at least one second node fixed to another side of the base.

### CROSS REFERENCE TO RELATED APPLICATION(S)

This application is a continuation of International Application No. PCT/KR2023/000643, filed on Jan. 13, 2023, in the Korean Intellectual Property Receiving Office, which is based on and claims priority to Korean Patent Applications No. 10-2022-0072399, filed on Jun. 14, 2022 and No. 10-2022-0018231, filed on Feb. 11, 2022, in the Korean Intellectual Property Office, the disclosures of which are incorporated by reference herein in their entireties.

### BACKGROUND

### 1. Field

This disclosure relates to a technique for implementing a small-sized connector for electrically coupling components of an electronic device.

### 2. Description of Related Art

In general, at least one connector may be disposed inside a housing of an electronic device to serve a function of electrically coupling components.

The connector may be classified into various types. For example, a Board To Board (BTB) connector may include a socket, a plug, or a receptacle. For example, the socket or the plug may be a male-type connector, and the receptacle may be a female-type connector. The socket and the receptacle may be connected by being inserted to each other.

A connector for a Flexible Printed Circuit Board (FPCB) (or a Flexible Printed Circuit (FPC) connector) may be configured such that a separate actuator is disposed to a base to maintain a connected state of the connector.

Due to a trend of implementing a small-sized connector, the existing connector may have a risk of damage to an actuator disposed to maintain a connected state between a male connector and a female connector.

In addition, the connector may deteriorate in terms of assembling due to an increase in an operation machine-hour of the actuator. For example, with the increase in the operation machine-hour of the actuator, assembly time may increase and/or an assembly jig may be required.

In addition, the connector may require an operation space of the actuator, and a space for mounting the connector may be increased.

In addition, the connector may decrease in rigidity and/or increase in work difficulty due to a decrease in an absolute mounting space of the connector.

### SUMMARY

Aspects will be set forth in part in the description which follows and, in part, will be apparent from the description, or may be learned by practice of the presented embodiments.

According to an aspect of the disclosure, an electronic device may include: a flexible printed circuit board (FPCB) contact electrically connected to a first electronic component; and a receptacle electrically connected to a second electronic component and to which the FPCB contact is detachably connected, where the receptacle includes: a base including a first face facing a first direction, a second face facing a second direction away from the first direction, and a side face including one side face and another side face perpendicularly facing the first and second directions, respectively; a support member fixed to the side face, facing the first face, and configured to support a locking state of the FPCB contact; at least one first node fixed to one side of the base, exposed on the first face, and connected to a first portion of the FPCB contact; at least one second node fixed to another side of the base, exposed on the first face, connected to a second portion of the FPCB contact, and provided between the at least one first node; and a first stopper provided at a first portion of the support member and configured to lock the locking state of the FPCB contact.

The support member may include: two ends fixed to the side face; and an upper portion provided over at least part of the FPCB contact in the locking state, and configured to support the locking state of the FPCB contact.

The first stopper may be provided at the upper portion.

The first stopper may include at least one stopping protrusion provided at the upper portion adjacent to the side face.

The at least one stopping protrusion may face the second direction by being bent at the upper portion.

The at least one stopping protrusion may further include: a first stopping protrusion provided adjacent to the one face of the side face; and a second stopping protrusion provided adjacent to the another face of the side face.

The FPCB contact may include a second stopper which is configured to stop at the first stopper in the locking state.

The second stopper may have a rectangular opening shape.

The FPCB contact may further include: a first face facing the first direction; and a second face facing the second direction, where at least part of the first face includes a stiffener.

When the FPCB contact is in the locking state, the stiffener may face the first direction.

The first face of the base may include: at least one inclined face inclined against a horizontal face; and a flat face including a plurality of slits configured to accommodate the at least one first node and the at least one second node, and which extends from the inclined face.

The at least one inclined face may be provided at a front area of the first face of the base.

A contact direction of the FPCB contact may correspond to the at least one inclined face, and the locking state of the FPCB contact may correspond to the horizontal.

The upper portion may include a bending portion opposite to the first stopper and configured to prevent a swelling of the upper portion in the first direction.

The bending portion may face the second direction.

A connector of an electronic device may include: a base including a first face facing a first direction, a second face facing a second direction away from the first direction, and a side face including one side face and another side face perpendicularly facing the first and second directions, respectively; a support member fixed to the base and facing the first face; at least one first node fixed to a side of the base, and exposed on the first face; at least one second node fixed to another side of the base, exposed on the first face, and provided between the at least one first node; and a first stopper provided at a first portion of the support member to lock a locking state.

The support member may include: an upper portion; and an end bent from the upper portion and fixed to the side face, where the first stopper is provided at the upper portion.

The first stopper may include at least one stopping protrusion provided at the upper portion adjacent to the side face.

The at least one stopping protrusion may face the second direction by being bent at the upper portion.

The upper portion may further include a bending portion opposite to the first stopper and configured to prevent a swelling of the upper portion in the first direction, where the bending portion faces the second direction.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a perspective view illustrating a front face of an electronic device according to an embodiment;

FIG. 2 is a perspective view illustrating a rear face of the electronic device of FIG. 1 according to an embodiment;

FIG. 3 is an exploded perspective view of the electronic device of FIG. 1 according to an embodiment;

FIG. 4 is a perspective view illustrating an assembled connector according to an embodiment;

FIG. 5 is a perspective view illustrating a separated connector according to an embodiment;

FIG. 6 is a perspective view illustrating a base according to an embodiment;

FIG. 7 is a perspective view illustrating a support member according to an embodiment;

FIG. 8 is a side view illustrating a first node according to an embodiment;

FIG. 9 is a side view illustrating a second node according to an embodiment;

FIG. 10A is a perspective view illustrating a connector before being locked according to an embodiment;

FIG. 10B is a cross-sectional view illustrating a connector before being locked according to an embodiment;

FIG. 11A is a perspective view illustrating a connector in the middle of being locked according to an embodiment;

FIG. 11B is a cross-sectional view illustrating a connector in the middle of being locked according to an embodiment;

FIG. 12A is a perspective view illustrating a connector after being locked according to an embodiment;

FIG. 12B is a cross-sectional view illustrating a connector after being locked according to an embodiment;

FIG. 13 is a plan view illustrating a connector according to an embodiment;

FIG. 14A illustrates a state of a first node before being locked according to an embodiment, and is a cross-sectional view cut along the line A-A′ of FIG. 13;

FIG. 14B illustrates a state of a first node after being locked according to an embodiment, and is a cross-sectional view cut along the line A-A′ of FIG. 13;

FIG. 15A illustrates a state of a second node before being locked according to an embodiment of the disclosure, and is a cross-sectional view cut along the line B-B′ of FIG. 13;

FIG. 15B illustrates the state of a second node after being locked according to an embodiment of the disclosure, and is a cross-sectional view cut along the line B-B′ of FIG. 13;

FIG. 16A illustrates a first stopper before being locked according to an embodiment of the disclosure, and is a cross-sectional view cut along the line C-C′ of FIG. 13;

FIG. 16B illustrates a first stopper after being locked according to an embodiment of the disclosure, and is a cross-sectional view cut along the line C-C′ of FIG. 13;

FIG. 17 is a perspective view illustrating a Flexible Printed Circuit Board (FPCB) contact before being locked according to an embodiment;

FIG. 18 is a perspective view illustrating a support member according to another embodiment; and

FIG. 19 is a cross-sectional view illustrating a structure of an FPCB contact according to an embodiment.

With regard to the description of the drawings, the same or similar reference numerals may be used to refer to the same or similar elements.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

The expression “A or B”, “at least one of A and/or B”, “one or more of A and/or B”, or the like used herein may include any one of or all possible combinations of items enumerated therewith. For example, “A or B”, “at least one of A and B”, or “at least one of A or B” may mean (1) including at least one A, (2) including at least one B, or (3) including both at least one A and at least one B.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

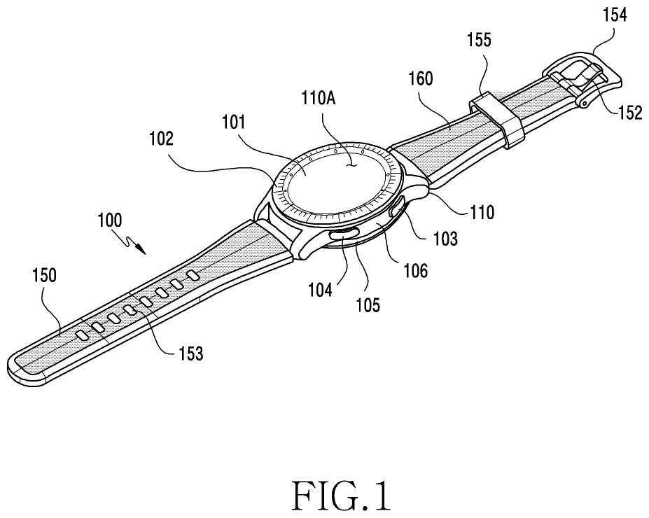

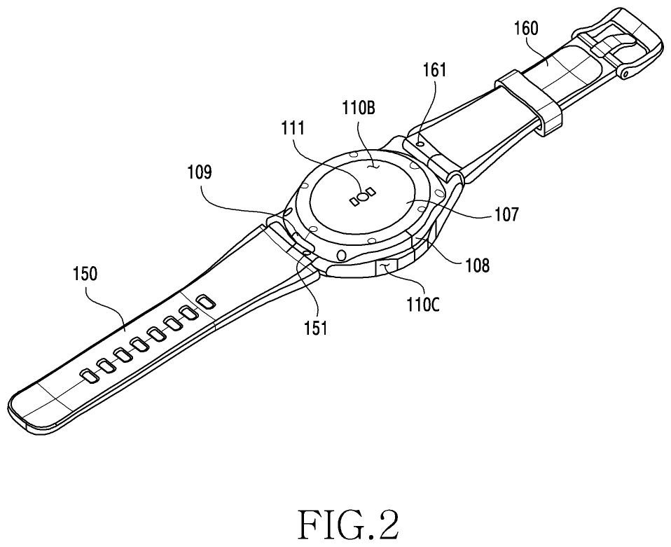

FIG. 1 is a perspective view illustrating a front face of an electronic device according to an embodiment. FIG. 2 is a perspective view illustrating a rear face of the electronic device of FIG. 1.

Referring to FIG. 1 and FIG. 2, an electronic device 100 according to an embodiment may include a housing 110 including a first face (or a front face) 110A, a second face (or a rear face) 110B, and a side face 110C surrounding a space between the first face 110A and the second face 110B, and binding members 150 and 160 coupled to at least part of the housing 110 and configured to detachably bind the electronic device 100 to a user's body part (e.g., a wrist, an ankle, etc.). In another embodiment, the housing may refer to a construction which constitutes part of the first face 110A, second face 110B, and side face 110C of FIG. 1. According to an embodiment, the first face 110A may be formed of a front plate 101 (e.g., a polymer plate or a glass plate including various coating layers) which is at least partially transparent in practice. The second face 110B may be formed of a rear plate 107 which is opaque in practice. For example, the rear plate 107 may be formed of coated or colored glass, ceramic, polymer, metal (e.g., aluminum, stainless steel (STS), or magnesium) or a combination of at least two of these materials. The side face 110C may be formed with a side bezel structure (or a “side member”) 106 coupled to the front plate 101 and the rear plate 107 and including metal and/or polymer. In some embodiments, the rear plate 107 and the side bezel structure 106 may be formed integrally and may include the same material (e.g., a metallic material such as aluminum). The binding members 150 and 160 may be formed of various materials and shapes. Integrated and multiple unit links may be formed to be mutually movable by using fabric, leather, rubber, urethane, metal, ceramic, or a combination of at least two of the above materials.

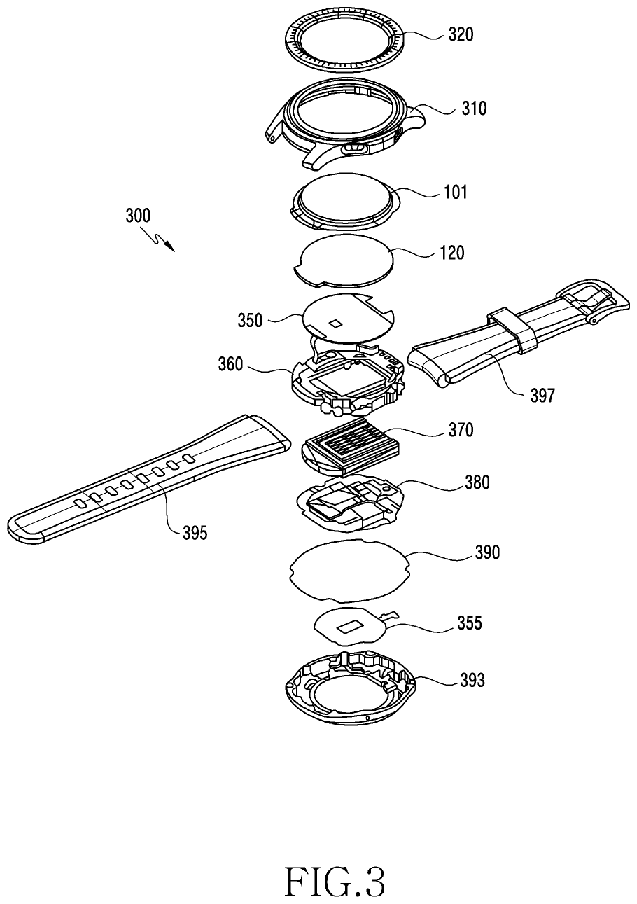

According to an embodiment, the electronic device 100 may include at least one or more of a display 120 (see FIG. 3), audio modules 105 and 108, a sensor module 111, key input devices 102, 103, and 104, and a connector hole 109. In some embodiments, the electronic device 100 may omit at least one of elements (e.g., the key input devices 102, 103, and 104, the connector hole 109, or the sensor module 111), or may additionally include other elements.

The display 120 according to an embodiment may be exposed through, for example, some portions of the front plate 101. The display 120 may have a shape corresponding to a shape of the front plate 101, and may have various shapes such as a circular shape, an elliptical shape, a polygonal shape, or the like. The display 120 may be disposed adjacent to or joined with a touch sensing circuit, a pressure sensor capable of measuring touch strength (pressure), and/or a fingerprint sensor.

The audio modules 105 and 108 according to an embodiment may include a microphone hole 105 and a speaker hole 108. The microphone hole 105 may have a microphone disposed inside thereof to acquire external sound, and in some embodiments, may have a plurality of microphones disposed to sense a sound direction. The speaker hole 108 may be used as an external speaker and a communication receiver. In some embodiments, the speaker hole 108 and the microphone hole 103 may be implemented with one hole, or the speaker (e.g., a piezo speaker) may be included without the speaker hole 108.

The sensor module 111 according to an embodiment may generate an electrical signal or data value corresponding to an internal operational state of the electronic device 100 or an external environmental state. The sensor module 111 may include, for example, a biometric sensor module 111 (e.g., a Heart Rate Monitoring (HRM) sensor) disposed to the second face 110B of the housing 110. The electronic device 100 may further include at least one of senor modules (not shown), for example, a gesture sensor, a gyro sensor, an atmospheric pressure sensor, a magnetic sensor, an acceleration sensor, a grip sensor, a color sensor, an Infrared (IR) sensor, a biometric sensor, a temperature sensor, a humidity sensor, and an illuminance sensor.

The key input devices 102, 103, and 104 according to an embodiment may include a wheel key 102 disposed to the first face 110A of the housing 110 and rotatable in at least one direction, and/or side key buttons 103 and 104 disposed to the side face 110C of the housing 110. The wheel key may have a shape corresponding to the shape of the front plate 102. In another embodiment, the electronic device 100 may not include some or all of the aforementioned key input devices 102, 103, and 104. The key input devices 102, 103, and 104, which are not included, may be implemented on the display 120 in a different form such as a soft key or the like. The connector hole 109 may accommodate a connector (for example, a Universal Serial Bus (USB) connector) for transmitting and receiving power and/or data with an external electronic device and may include another connector hole capable of accommodating a connector for transmitting and receiving an audio signal with the external electronic device. The electronic device 100 may further include, for example, a connector cover which covers at least part of the connector hole 109 and blocks external foreign substances from entering the connector hole.

The binding members 150 and 160 according to an embodiment may use locking members 151 and 161 so as to be detachably bound to at least some regions of the housing 110. The binding members 150 and 160 may include one or more of a fixing member 152, a fixing member locking hole 153, a band guide member 154, and a band fixing ring 155.

The fixing member 152 according to an embodiment may be configured to fix the housing 110 and the binding members 150 and 160 to the user's body part (e.g., the wrist, the ankle, etc.). The fixing member locking hole 153 may fix the housing 110 and the binding members 150 and 160 to the user's body part in accordance with the fixing member 152. The band guide member 154 may be configured to restrict a movement range of the fixing member 152 when the fixing member 152 is locked to the fixing member locking hole 153, so that the binding members 150 and 160 are bound in close contact with the user's body part. The band fixing ring 155 may restrict the movement range of the binding members 150 and 160, in a state where the fixing member 152 and the fixing member locking hole 153 are locked.

FIG. 3 is an exploded perspective view of the electronic device 100 of FIG. 1.

Referring to FIG. 3, an electronic device 300 according to an embodiment may include a side bezel structure 310, a wheel key 320, the front plate 101, the display 120, a first antenna 350, a second antenna 355, a support member 360 (e.g., a bracket), a battery 370, a Printed Circuit Board (PCB) 380, a sealing member 390, a rear plate 393, and binding member 395 and 397. At least one of the elements of the electronic device 300 may be the same as or similar to at least one of the components of the electronic device 100 of FIG. 1 or FIG. 2, and redundant descriptions will be omitted hereinafter. The support member 360 may be coupled with the side bezel structure 310 by being disposed inside the electronic device 300, or may be formed integrally with respect to the side bezel structure 310. The support member 360 may be formed of, for example, a metallic material and/or non-metallic material (e.g., polymer). The display 120 may be coupled to one face of the support member 360, and the PCB 380 may be coupled to the other face thereof. A processor, a memory, and/or an interface may be mounted on the PCB 380. The processor may include, for example, one or more of a central processing unit, an application processor, a Graphic Processing Unit (GPU), sensor processor, and a communication processor.

The memory according to an embodiment may include, for example, a volatile memory or a non-volatile memory. The interface may include, for example, a High Definition Multimedia Interface (HDMI), a Universal Serial Bus (USB) interface, a Secure Digital (SD) card interface, and/or an audio interface. For example, the interface may electrically or physically couple the electronic device 300 and the external electronic device, and may include a USB connector, an SD card/MMC connector, or an audio connector.

As a device for supplying power to at least one element of the electronic device 300, the battery 370 may include, for example, a non-rechargeable primary cell, a rechargeable secondary cell, or a fuel cell. At least part of the battery 370 may be disposed on the same plane substantially with respect to, for example, the PCB 380. The battery 370 may be disposed integrally inside the electronic device 300, or may be detachably disposed with respect to the electronic device 300.

The first antenna 350 may be disposed between the display 120 and the support member 360. The first antenna 350 may include, for example, a Near Field Communication (NFC) antenna, a wireless charging antenna, and/or a Magnetic Secure Transmission (MST) antenna. The first antenna 350 may perform short-range communication, for example, with the external electronic device or may wirelessly transmit/receive power required for charging, and may transmit a short-range communication signal or a magnetic-based signal including payment data. In another embodiment, an antenna structure may be formed by at least part of the side bezel structure 310 and/or the support member 360 or a combination thereof.

The second antenna 355 according to an embodiment may be disposed between the PCB 380 and the rear plate 393. The second antenna 355 may include, for example, an NFC antenna, a wireless charging antenna, and/or an MST antenna. The second antenna 355 may perform short-range communication, for example, with the external electronic device or may wirelessly transmit/receive power required for charging, and may transmit a short-range communication signal or a magnetic-based signal including payment data. In another embodiment, an antenna structure may be formed by at least part of the side bezel structure 310 and/or the rear plate 393 or a combination thereof.

The sealing member 390 according to an embodiment may be located between the side bezel structure 310 and the rear plate 393. The sealing member 390 may be configured to block moisture and foreign substances from being introduced from the outside to a space surrounded by the side bezel structure 310 and the rear plate 393.

Hereinafter, a structure of at least one connector disposed inside a housing of an electronic device will be described with reference to the accompanying drawings.

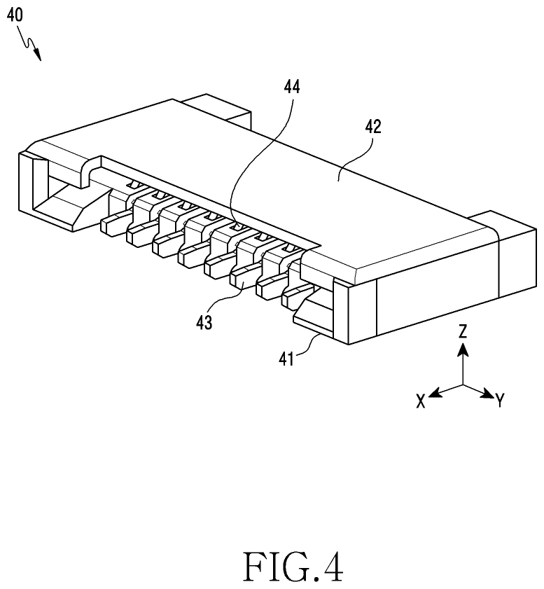

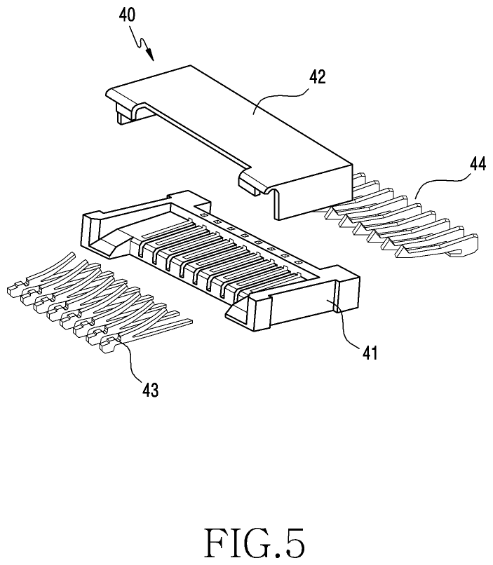

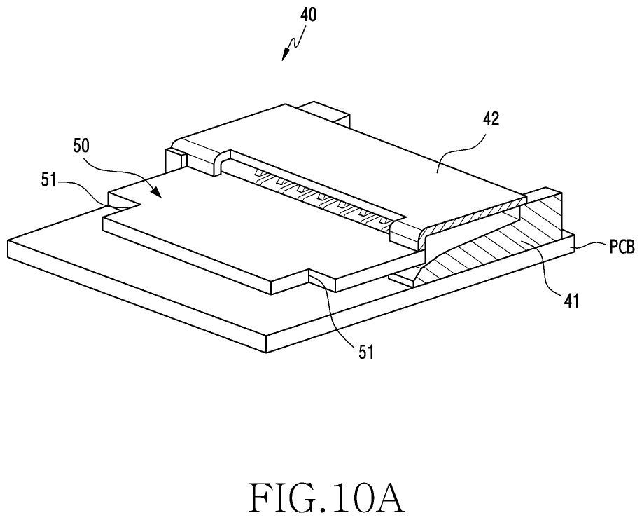

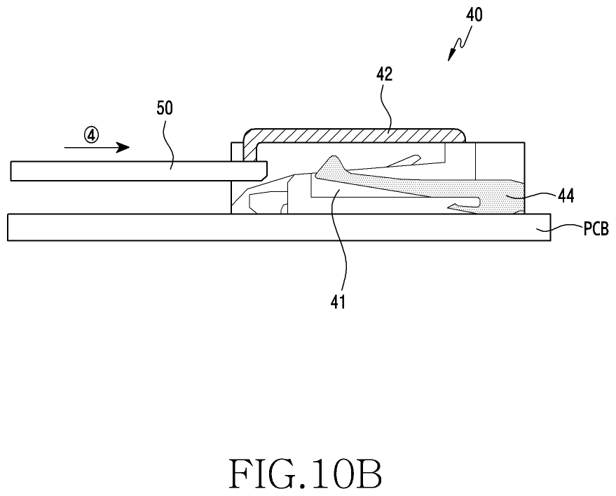

FIG. 4 is a perspective view illustrating an assembled connector according to an embodiment. FIG. 5 is a perspective view illustrating a separated connector according to an embodiment. FIG. 10A is a perspective view illustrating a connector before being locked according to an embodiment.

Referring to FIG. 4, FIG. 5, and FIG. 10A, a Cartesian coordinate system is used, where an X-axis may refer to a vertical direction of the connector, a Y-axis may refer to a horizontal direction of the connector, and a Z-axis may refer to a thickness direction of the connector.

The connector according to an embodiment may electrically couple electronic components, and may be, for example, used to electrically couple a display accommodated in the electronic device and a PCB (e.g., the PCB 380 of FIG. 3) spaced apart from the display (e.g., the display 120 of FIG. 3). According to an embodiment, the display may use a Flexible Printed Circuit Board (FPCB) so as to be electrically coupled to the PCB, and the FPCB may have a contact disposed to one end so as to be connected to the PCB.

The connector according to an embodiment may include an FPCB contact 50 and a receptacle 40. According to an embodiment, the FPCB contact 50 may be electrically coupled to a first electronic component, and the receptacle 40 may be electrically coupled to a second electronic component. For example, the first electronic component may include a display (e.g., the display 120 of FIG. 3), and the second electronic component may include a PCB (e.g., the PCB 380 of FIG. 3). For example, the receptacle 40 may be disposed to one face of the PCB.

According to an embodiment, the FPCB contact 50 may be connected to or separated from the receptacle 40. According to an embodiment, after the FPCB contact 50 is locked to the receptacle 40, a connected state may be maintained.

According to an embodiment, the receptacle may include a base 41, a support member 42, and first and second nodes 43 and 44. According to an embodiment, the support member 42 may be fixed to the base 41, and the first node 43 and the second node 44 may be coupled thereto.

According to an embodiment, the receptacle 40 may be coupled with the support member 42 towards a first portion (e.g., an upper portion, a +Z-axis direction) with respect to the base 41, may be coupled with the first node 43 towards a second portion (e.g., a front direction, a +X-axis direction), and may be coupled with the second node 44 towards a third portion (e.g., a rear direction, a −X-direction).

According to an embodiment, the base 41 may be formed of a Liquid Crystal Polymer (LCP) material. The support member 42 may be formed of a Steel Use Stainless (SUS) material. The first node 43 and the second node 44 may be formed of a copper material.

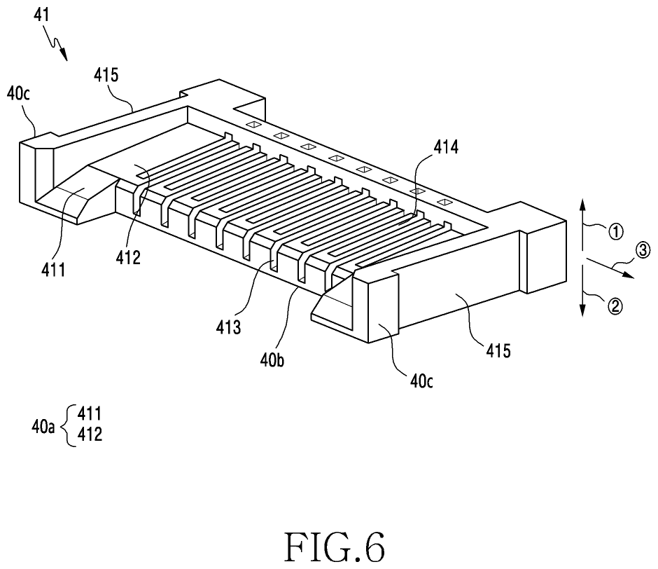

FIG. 6 is a perspective view illustrating a base according to an embodiment.

Referring to FIG. 6, the base 41 according to an embodiment may include a first face 40a, a second face 40b, and a side face 40c. According to an embodiment, the first face 40a may face a first direction \textcircled{1}, and the second face 40b may face a second direction \textcircled{2}opposite to the first direction \textcircled{1}, and the side face 40c may face a third direction \textcircled{3}substantially perpendicular to the first direction \textcircled{1} and the second direction \textcircled{2}. For example, the first direction \textcircled{1} may be an upward direction, and the second direction \textcircled{2} may be a downward direction. For example, the first and second directions \textcircled{1} and \textcircled{2} may be vertical directions, and the third direction \textcircled{3} may be a horizontal direction.

According to an embodiment, the first face 40a may include at least one inclined face 411 and a flat face 412. According to an embodiment, the inclined face 411 may be located in a front direction of the first face 40a, and the flat face 412 may be located in a rear direction of the first face 40a. For example, the inclined face 411 may face a direction inclined against a horizontal face. According to an embodiment, the flat face 412 may have a plurality of slits 413 and 414 formed to fix the first node 43 and the second node 44. According to an embodiment, the first node 43 may be assembled to the slit 413 by being pressed from the front direction to the rear direction, and the second node 44 may be assembled to the slit 414 by being pressed from the rear direction to the front direction. According to an embodiment, the inclined direction facing the inclined face 411 may face the support member 42 with respect to the horizontal direction.

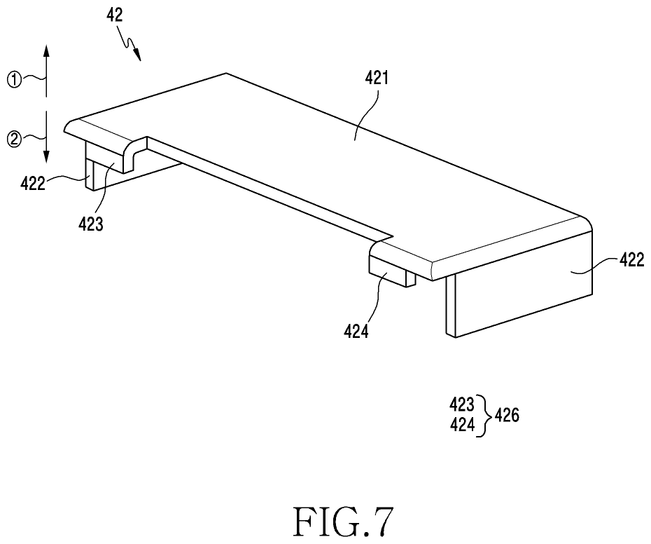

According to an embodiment, at least one fixing groove 415 may be formed at the side face 40c. According to an embodiment, the fixing groove 415 may be a groove on which each of both ends (e.g., both ends 422 of FIG. 7) of the support member 42 is mounted.

FIG. 7 is a perspective view illustrating a support member according to an embodiment.

Referring to FIG. 7, the support member 42 according to an embodiment may include an upper portion 421 and both ends 422. According to an embodiment, the support member 42 may be coupled to the base 41, as a component formed by bending a thin metal plate multiple times. According to an embodiment, the upper portion 421 may have a substantially flat shape, as a portion which supports a connected connector. The both ends 422 according to an embodiment may be formed by being bent approximately 90 degrees from the upper portion 421. According to an embodiment, the both ends 422 may be a fixed portion which fixes the support member 42 to the base 41.

According to an embodiment, a first stopper 426 may be formed at a first portion of the support member 42. For example, the first portion of the support member 42 may be an edge of one side of the support portion 421. According to an embodiment, the first stopper 426 may be located at one side of the upper portion 421. According to an embodiment, the first stopper 426 may include at least one stopping protrusions 423 and 424. For example, the stopping protrusion may include a first stopping protrusion 423 and a second stopping protrusion 424. According to an embodiment, each of the first stopping protrusion 423 and the second stopping protrusion 424 may be formed by being bent at the upper portion 421, and may face a second direction \textcircled{2} after being bent.

According to an embodiment, the first stopping protrusion 423 may be located close to one side face 40d, and the second stopping protrusion 424 may be located close to another side face 40c. For example, the first stopping protrusion 423 and the second stopping protrusion 424 may be disposed in shapes and/or locations symmetrical to each other with respect to a virtual axis corresponding to an X-axis (e.g., the X-axis of FIG. 4).

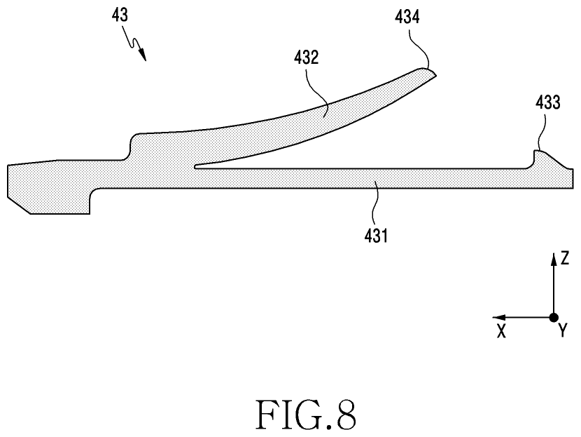

FIG. 8 is a side view illustrating the first node 43 according to an embodiment.

Referring to FIG. 8, according to an embodiment, the plurality of first nodes 43 may be arranged in parallel on a flat face (e.g., the flat face 412 of FIG. 6) of the base 41. According to an embodiment, the first node 43 may be coupled at least in part to each slot (e.g., the slot 413 of FIG. 6) while moving from a front direction of the base 41 to a rear direction thereof.

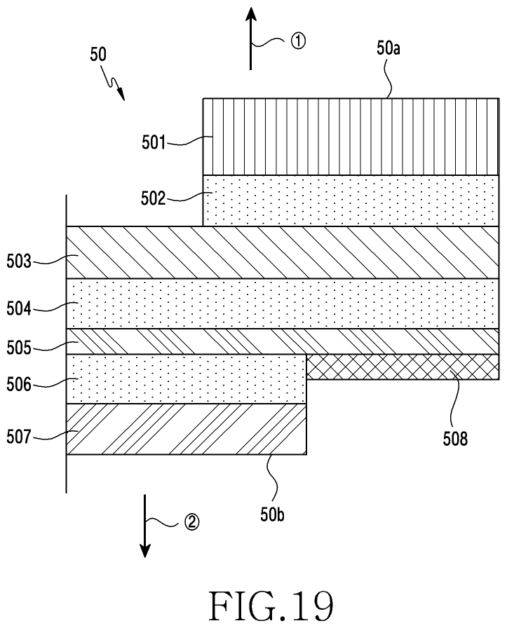

According to an embodiment, the first node 43 may include a fixing portion 431 coupled to the slit 413 to fix the first node 43, and a contact 432 for being in contact elastically with the FPCB contact 50. According to an embodiment, the fixing portion 431 may be a fixed end, and the contact 432 may be a free end. According to an embodiment, an end of the fixing portion 431 may be a stopping protrusion 433 which prevents it from being detached after being assembled to the slit 413 of the base 41, and the end of the contact 432 may be a contact point 434 for being in contact with a first portion (e.g., a node, or a portion of the copper wire layer 505 of FIG. 19) of the FPCB contact.

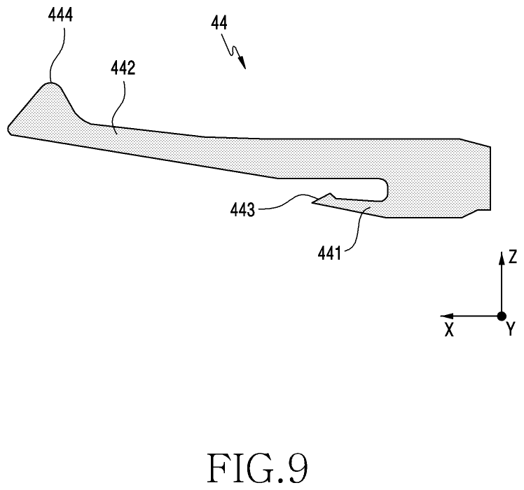

FIG. 9 is a side view illustrating the second node 44 according to an embodiment.

Referring to FIG. 9, according to an embodiment, the plurality of second nodes 44 may be arranged in parallel on the flat face 412 of the base 41. According to an embodiment, the second node 44 may be coupled at least in part to the slit 413 while moving from a rear direction of the base 41 to a front direction thereof.

According to an embodiment, the second node 44 may include a fixing portion 441 coupled to the slit 413 to fix the second node 44, and a contact 442 for being in contact elastically with the FPCB contact. According to an embodiment, the fixing portion 441 may be a fixed end, and the contact 442 may be a free end. According to an embodiment, an end of the fixing portion 441 may be a stopping protrusion 443 which prevents it from being detached after being assembled to the slit 413 of the base 41, and the end of the contact 442 may be a contact point 444 for being in contact with a second portion (e.g., a node, or another portion of the copper wire layer 505 of FIG. 19) of the FPCB contact.

FIG. 10A is a perspective view illustrating a connector in a first state (e.g., before being locked) according to an embodiment. FIG. 10B is a cross-sectional view illustrating the connector in the first state (e.g., before being locked) according to an embodiment.

According to an embodiment, the first state of the connector may refer to a state before the FPCB contact 50 is locked to the receptacle 40. A second state of the connector may refer to a state in which the FPCB contact 50 is being inserted into the receptacle 40. A third state of the connector may refer to a state in which the FPCB contact 50 is not pulled out from the receptacle 40 since the FPCB contact 50 is locked, after being inserted to the receptacle 40, due to a stopping structure between a first stopper (e.g., the first stopper 426 of FIG. 7) and a second stopper (e.g., a second stopper 51 of FIG. 10A).

Referring to FIG. 10A and FIG. 10B, the connector according to an embodiment may insert the FPCB contact 50 to a space between the support member 42 and the base 41, in order to lock the FPCB contact 50 to the receptacle 40. According to an embodiment, an initial insertion direction \textcircled{4} of the FPCB contact 50 may be substantially horizontal.

According to an embodiment, the FPCB contact 50 may include a second stopper 51. According to an embodiment, the second stopper 51 may be one pair, each of which may be formed to be symmetric to a virtual axis corresponding to an X-axis (e.g., the X-axis of FIG. 4). For example, the second stopper 51 may have an opening shape formed by cutting it approximately 90 degrees.

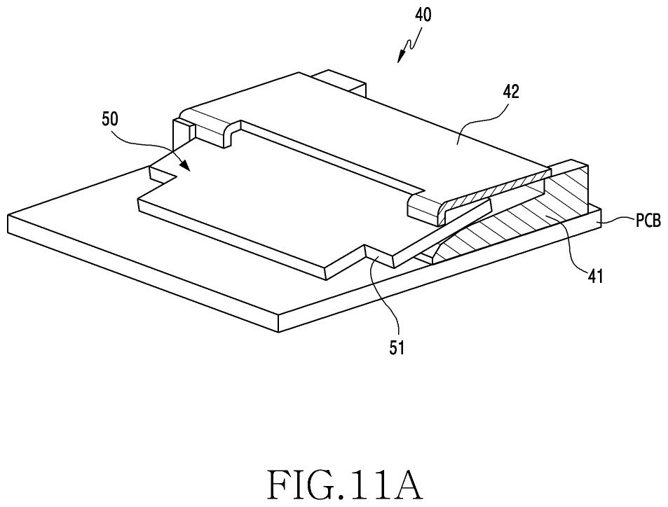

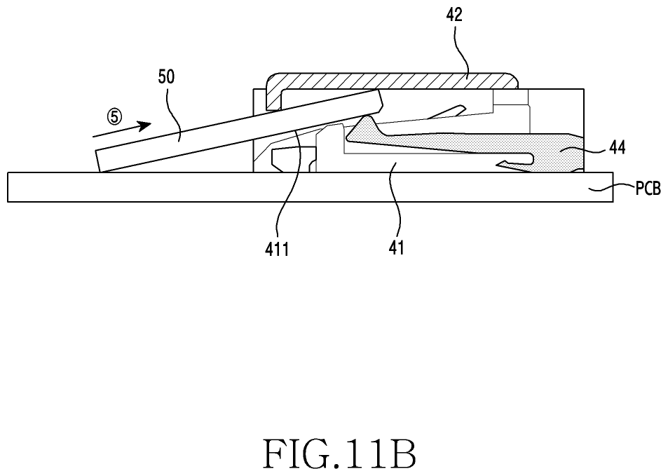

FIG. 11A is a perspective view illustrating a connector in a second state (e.g., in the middle of being locked) according to an embodiment. FIG. 11B is a cross-sectional view illustrating the connector in the second state (e.g., in the middle of being locked) according to an embodiment.

Referring to FIG. 11A and FIG. 11B, when the connector according to an embodiment inserts the FPCB contact 50 to a space between the support member 42 and the base 41 and then continuously press the FPCB contact 50 in a contact direction (e.g., an arrow direction \textcircled{4} of FIG. 10B) in order to lock the FPCB contact 50 to the receptacle 40, the FPCB contact 50 may move forward slidably in an inclined direction (e.g., an arrow direction \textcircled{5} of FIG. 11B). According to an embodiment, the FPCB contact 50 may serve as a sliding guide along the inclined direction \textcircled{5}due to the at least one inclined face 411 formed at a front portion of the base 41.

According to an embodiment, a movement of the sliding guide of the FPCB contact 50 may bring a contact node of the FPCB contact 50 to be in contact with the second node 44.

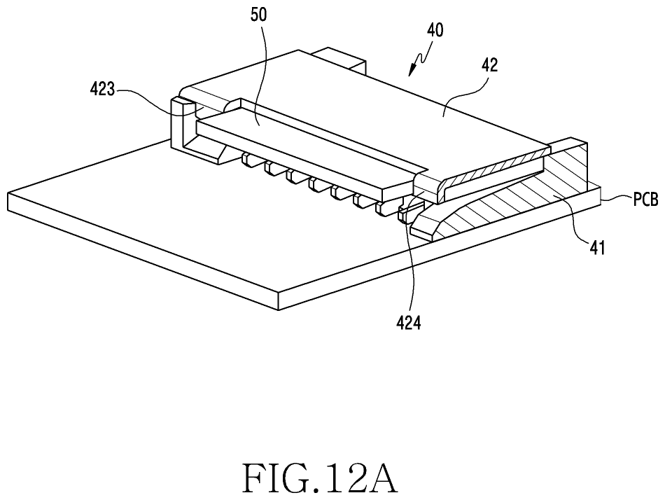

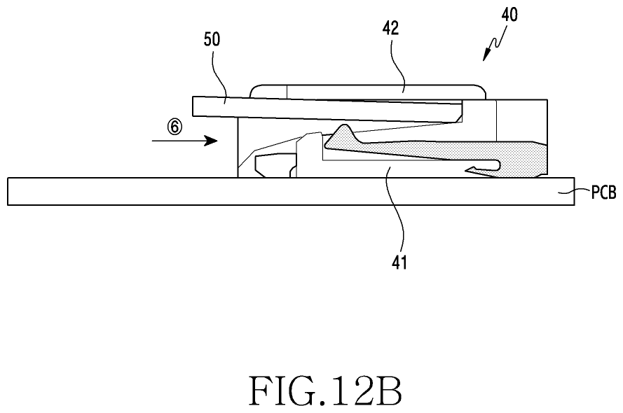

FIG. 12A is a perspective view illustrating a connector in a third state (e.g., after being locked) according to an embodiment. FIG. 12B is a cross-sectional view illustrating the connector in the third state (e.g., after being locked) according to an embodiment.

Referring to FIG. 12A and FIG. 12B, when the connector according to an embodiment inserts the FPCB contact 50 to a space between the support member 42 and the base 41 in an arrow direction \textcircled{6} in order to lock the FPCB contact 50 to the receptacle 40, the first stopper (e.g., the first stopper 426 of FIG. 7) may be locked after being in touch with the second stopper (e.g., the second stopper 51 of FIG. 10A). According to an embodiment, a locking state of the FPCB contact 50 may be stably maintained by being stopped at the first stopper 426 and the second stopper 51.

According to an embodiment, in order to separate the FPCB contact 50 from the receptacle 40, the FPCB contact 50 may be separated by reversely performing the aforementioned operation.

According to an embodiment, when the FPCB contact 50 is pushed or pressed downward (e.g., the second direction \textcircled{2} of FIG. 6) in the third state of the connector, the FPCB contact 50 may be in an inclined state. The second state of the connector may be in a state where a locking state (e.g., a stopping state) of a first stopper (e.g., the first stopper 426 and second stopper 51 of FIG. 7) is released. Next, the FPCB contact 50 which is released from the locking state may be separated from the receptacle 40 by pulling it in an X-axis direction (e.g., the X-axis direction of FIG. 4).

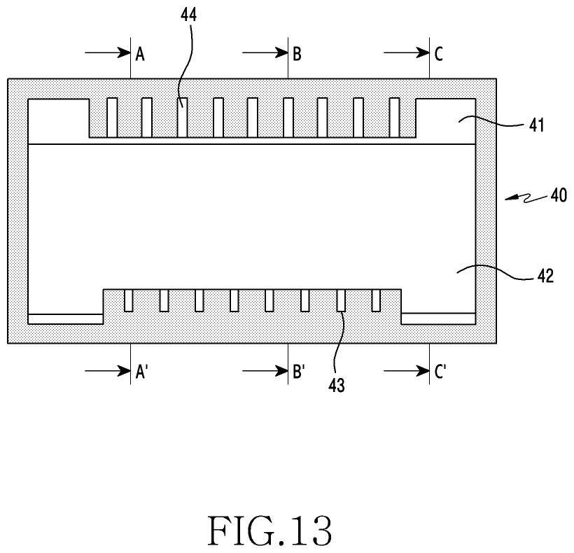

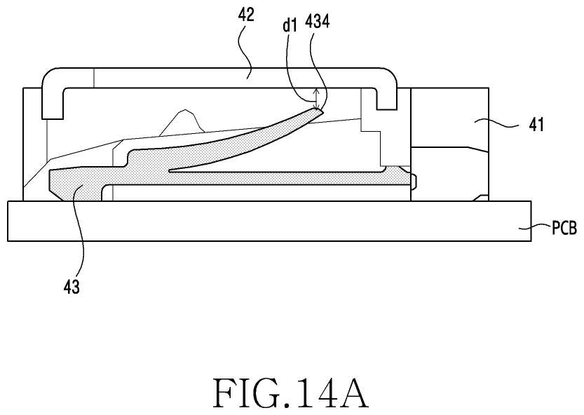

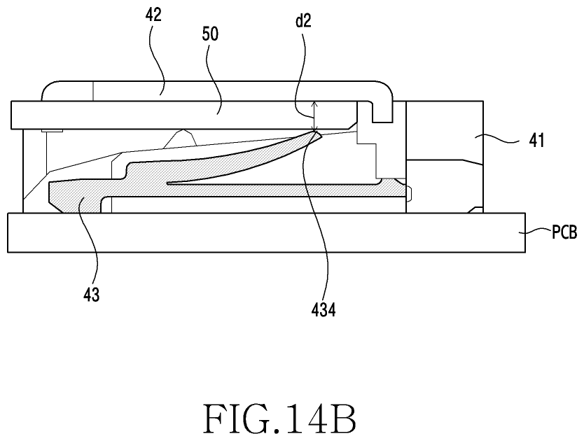

FIG. 13 is a plan view illustrating a connector according to an embodiment. FIG. 14A illustrates a state of the first node 43 before being locked according to an embodiment, and is a cross-sectional view cut along the line A-A′ of FIG. 13. FIG. 14B illustrates a state of the first node 43 after being locked according to an embodiment, and is a cross-sectional view cut along the line A-A′ of FIG. 13.

Referring to FIG. 13 to FIG. 14B, according to an embodiment, when the FPCB contact 50 is inserted to the receptacle 40, the FPCB contact 50 may be connected to the contact point 434. For example, the FPCB contact 50 may be connected to the contact point 434 of the first node 43, in a second state and/or third state of the connector. According to an embodiment, the contact point 434 may be located at an end of the first node 43.

According to an embodiment, when a distance between a bottom face of the support member 42 and the contact point 434 is defined as a first distance d1 in a state before the FPCB contact 50 is locked to the receptacle 40, and a distance between the bottom face of the support member 42 and the contact point 434 is defined as a second distance d2 in a state after the FPCB contact 50 is locked to the receptacle 40, the second distance d2 may be greater than the first distance d1.

According to an embodiment, since it is a state where an end (e.g., the contact point 434) of the first node 43 is elastically supported, the FPCB contact 50 and the contact point 434 may stably maintain a connected state.

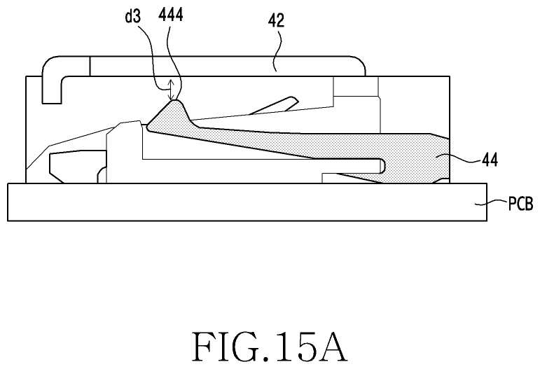

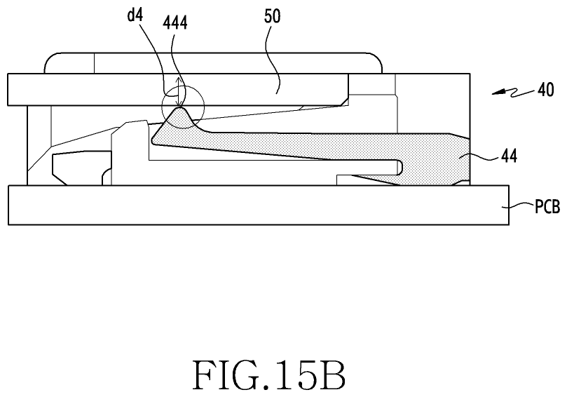

FIG. 15A illustrates a state of the second node 44 before being locked according to an embodiment of the disclosure, and is a cross-sectional view cut along the line B-B′ of FIG. 13. FIG. 15B illustrates the state of the second node 44 after being locked according to an embodiment of the disclosure, and is a cross-sectional view cut along the line B-B′ of FIG. 13.

Referring to FIG. 15A and FIG. 15B, according to an embodiment, when the FPCB contact 50 is continuously pressed in a sixth direction (e.g., the sixth direction \textcircled{6} of FIG. 12B) after being inserted to the receptacle 40, the FPCB contact 50 may be connected to the contact point 444 of the second node 44. For example, the FPCB contact 50 may be connected to the contact point 444 of the second node 44, in the second state and/or third state of the connector. According to an embodiment, the contact point 444 may be located at an end of the second node 44.

According to an embodiment, when a distance between a bottom face of the support member 42 and the contact point 434 is defined as a third distance d3 in a state before the FPCB contact 50 is locked to the receptacle 40, and a distance between the bottom face of the support member 42 and the contact point 434 is defined as a fourth distance d4 in a state after the FPCB contact 50 is locked to the receptacle 40, the fourth distance d4 may be greater than the third distance d3.

According to an embodiment, since it is a state where an end (e.g., the contact point 444) of the second node 44 is elastically supported, the FPCB contact 50 and the contact point 444 may stably maintain a locking state.

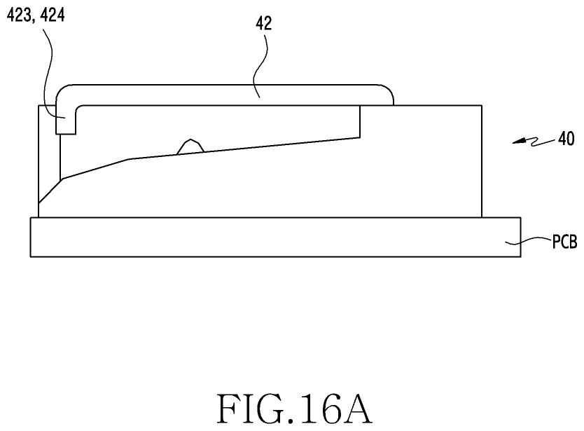

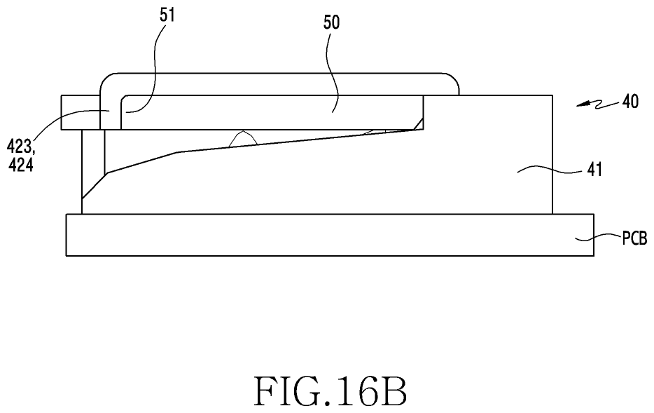

FIG. 16A illustrates the first stopper 426 before being locked according to an embodiment of the disclosure, and is a cross-sectional view cut along the line C-C′ of FIG. 13. FIG. 16B illustrates the first stopper 426 after being locked according to an embodiment of the disclosure, and is a cross-sectional view cut along the line C-C′ of FIG. 13.

Referring to FIG. 16A and FIG. 16B, according to an embodiment, when the FPCB contact 50 is continuously pressed after being inserted to the receptacle 40, the second stopper 51 of the FPCB contact 50 may be in a locking state where it is stopped at the first stopper 426. According to an embodiment, the locking state of the FPCB contact 50 may be stably maintained by being stopped between the first stopper 426 and the second stopper 51.

According to an embodiment, in a state where the FPCB contact 50 is separated from the receptacle 40, when the locked FPCB contact 50 is pressed downward (e.g., the second direction \textcircled{2} of FIG. 6), subsequently, the second stopper 51 may be released from a state of being locked with the first stopper 426. Next, by moving the FPCB contact 50 in an inclined direction while separating it in a direction opposite to a pressing direction, the FPCB contact 50 may be separated from the receptacle 40.

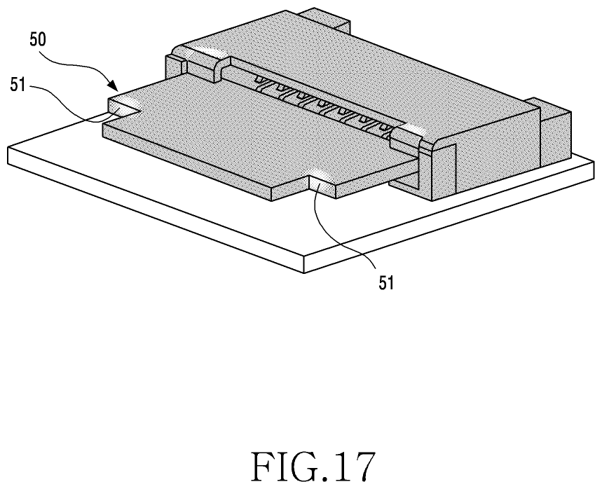

FIG. 17 is a perspective view illustrating an FPCB contact before being locked according to an embodiment.

Referring to FIG. 17, according to an embodiment, the FPCB contact 50 may include the second stopper 51 stopped at the first stopper 426 in order to maintain a locking state, after being locked to the receptacle 40. For example, the second stopper 51 may be formed to be symmetric to both ends, as a rectangular opening shape.

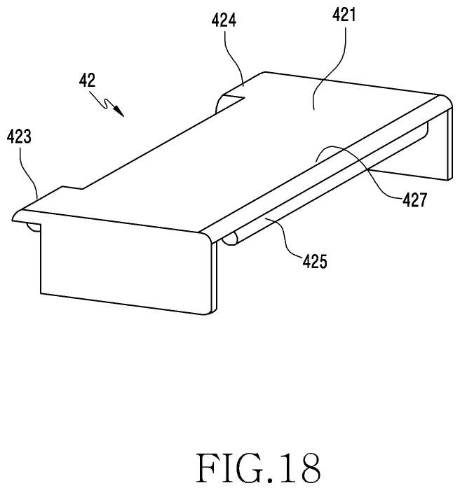

FIG. 18 is a perspective view illustrating a support member according to another embodiment.

Referring to FIG. 18, according to an embodiment, when the FPCB contact 50 is connected to the receptacle 40, a phenomenon (a swelling phenomenon) in which the upper portion 421 of the support member 42 is swollen in a first direction (e.g., the first direction \textcircled{1} of FIG. 6) may occur. The occurrence of the phenomenon in which the upper portion 421 of the support member 42 is swollen may result in an increase in a height of locking the connector or a decrease in contact stability.

In order to prevent this, the support member 42 according to an embodiment may be formed at the upper portion 421, and a bending portion 425 may be additionally formed at a point 427 opposite to the first stopper 426 to prevent the swelling phenomenon. According to an embodiment, the support member 42 may suppress the swelling phenomenon of the upper portion 421 by means of the bending portion 425.

FIG. 19 is a cross-sectional view illustrating a structure of an FPCB contact according to an embodiment.

Referring to FIG. 19, according to an embodiment, the FPCB contact 50 may include the first face 50a facing a first direction \textcircled{1}(e.g., an upward direction) and the second face 50b facing a second direction \textcircled{2}(e.g., a downward direction) opposite to the first face 50a. The FPCB contact 50 may be disposed to one end of an FPCB, as a connector for the FPCB. According to an embodiment, the FPCB contact 50 may have a stiffener 501 attached to one side with respect to a base film 503 by means of a first adhesive layer 502, and may have a copper line layer 505 attached to the other side by means of a second adhesive layer 504. According to an embodiment, a surface processing layer 508 may be formed at one portion of the copper wire layer 505, and another portion thereof may have a film protective layer 507 attached by a third adhesive layer 506.

According to an embodiment, when the FPCB contact 50 is locked to the receptacle 40, the stiffener 501 may be disposed to face a first direction \textcircled{1}, and the film protective layer 507 may be disposed to face a second direction \textcircled{2}. According to an embodiment, when the FPCB contact 50 is extracted (or separated), the stiffener 501 may be located to face the first direction (e.g., the first direction \textcircled{1} of FIG. 6), in order to prevent damage/breakage or the like of a contact face of the second stopper 51 and to increase extraction force.

According to an embodiment, an electronic device may include: a Flexible Printed Circuit Board (FPCB) contact which is electrically coupled to a first electronic component; and a receptacle which is electrically coupled to a second electronic component and to/from which the FPCB contact is connected/separated. The receptacle may include: a base including a first face disposed to face a first direction, a second face disposed to face a second direction facing away from the first direction, and one face and the other face perpendicularly facing the first and second directions, respectively; a support member fixed to the side face to face the first face and supporting a locking state of the FPCB contact; at least one first node fixed to one side of the base, disposed to be exposed on the first face, and connected to a first portion of the FPCB contact; at least one second node fixed to the other side of the base, disposed to be exposed on the first face, connected to a second portion of the FPCB contact, and arranged between the first nodes; and a first stopper formed at a first portion of the support member and locking a locking state of the FPCB contact.

According to an embodiment, the support member may include: both ends fixed to the side face; and an upper portion surrounding at least part of the locked FPCB contact, and supporting the locking state of the locked FPCB contact.

According to an embodiment, at least one or more of the first stoppers may be formed at the upper portion.

According to an embodiment, the first stopper may include at least one stopping protrusion formed at the upper portion proximate to the side face.

According to an embodiment, the stopping protrusion may be formed to face the second direction by being bent at the upper portion.

According to an embodiment, the stopping protrusion may include: a first stopping protrusion located proximate to the side face of one side; and a second stopping protrusion located proximate to the side face of the other side.

According to an embodiment, the FPCB contact may further include a second stopper which is stopped at the first stopper, when the FPCB contact is locked to the receptacle.

According to an embodiment, the second stopper may have a rectangular opening shape.

According to an embodiment, the FPCB contact may include: a first face facing the first direction; and a second face facing the second direction. At least part of the first face may include a stiffener.

According to an embodiment, the FPCB contact may be locked to the receptacle, the stiffener is disposed to face the first direction.

According to an embodiment, the first face may include: at least one inclined faces formed to be inclined against a horizontal face; and a flat face on which a plurality of slits are formed such that each of the first node and the second node is assembled thereto, and which extends from the inclined face.

According to an embodiment, the inclined face may be formed at a front area of the first face.

According to an embodiment, the FPCB contact may have a contact direction inclined towards the receptacle due to the inclined face. A locking state of the FPCB contact may be horizontal.

According to an embodiment, the upper portion may further include a bending portion to prevent from being swollen in the first direction at a point opposite to a portion where the first stopper is formed.

According to an embodiment, the bending portion may be formed to face the second direction.

According to an embodiment, a connector of an electronic device may include: a base including a first face disposed to face a first direction, a second face disposed to face a second direction facing away from the first direction, and one face and the other face perpendicularly facing the first and second directions, respectively; a support member fixed to the side face to face the first face; at least one first node fixed to one side of the base, and disposed to be exposed on the first face; at least one second node fixed to the other side of the base, disposed to be exposed on the first face, and arranged between the first nodes; and a first stopper formed at a first portion of the support member to lock a locking state.

According to an embodiment, the support member may include: a flat upper portion; and an end bent at the upper portion and fixed to the side face. At least one or more of the first stoppers may be formed at the upper portion.

According to an embodiment, the first stopper may include at least one stopping protrusion formed at the upper portion proximate to the side face.

According to an embodiment, the stopping protrusion may be formed to face the second direction by being bent at the upper portion.

According to an embodiment, the upper portion may further include a bending portion to prevent from being swollen in the first direction at a point opposite to a portion where the first stopper is formed. The bending portion may be formed to face the second direction.

A connector according to an embodiment may dispose a mechanical device which holds a connecting device of the connector instead of an actuator, thereby eliminating a risk of damage to the actuator.

The connector according to an embodiment may dispose the mechanical device which holds the connecting device of the connector instead of the actuator, thereby improving assembling due to a decrease in an operation machine-hour of the actuator.

The connector according to an embodiment may not require an operation space of the actuator, thereby decreasing a size of the connector.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device comprising:
a flexible printed circuit board (FPCB) contact electrically connected to a first electronic component; and
a receptacle electrically connected to a second electronic component and to which the FPCB contact is detachably connected,
wherein the receptacle comprises:
a base including a first face facing a first direction, a second face facing a second direction away from the first direction, and a side face including one side face and another side face perpendicularly facing the first and second directions, respectively;
a support member fixed to the side face, facing the first face, and configured to support a locking state of the FPCB contact;
at least one first node fixed to one side of the base, exposed on the first face, and connected to a first portion of the FPCB contact;
at least one second node fixed to another side of the base, exposed on the first face, connected to a second portion of the FPCB contact, and arranged between the at least one first node; and
a first stopper formed at a first portion of the support member and configured to lock the locking state of the FPCB contact.

2. The electronic device of claim 1, wherein the support member comprises:
two ends fixed to the side face; and
an upper portion surrounding at least part of the FPCB contact in the locking state, and configured to support the locking state of the FPCB contact.

3. The electronic device of claim 2, wherein the first stopper is formed at the upper portion.

4. The electronic device of claim 3, wherein the first stopper comprises at least one stopping protrusion formed at the upper portion adjacent to the side face.

5. The electronic device of claim 4, wherein the at least one stopping protrusion faces the second direction by being bent at the upper portion.

6. The electronic device of claim 5, wherein the at least one stopping protrusion further comprises:
a first stopping protrusion located adjacent to the one side face; and
a second stopping protrusion located adjacent to the another side face.

7. The electronic device of claim 1, wherein the FPCB contact comprises a second stopper which is configured to stop at the first stopper in the locking state.

8. The electronic device of claim 7, wherein the second stopper has a rectangular opening shape.

9. The electronic device of claim 7, wherein the FPCB contact further comprises:
a first face facing the first direction; and
a second face facing the second direction,
wherein at least part of the first face includes a stiffener.

10. The electronic device of claim 9, wherein, when the FPCB contact is in the locking state, the stiffener faces the first direction.

11. The electronic device of claim 1, wherein the first face of the base comprises:
at least one inclined face inclined against a horizontal face; and
a flat face comprising a plurality of slits configured to accommodate the at least one first node and the at least one second node, and which extends from the inclined face.

12. The electronic device of claim 11, wherein the at least one inclined face is formed at a front area of the first face of the base.

13. The electronic device of claim 12, wherein a contact direction of the FPCB contact corresponds to the at least one inclined face, and the locking state of the FPCB contact corresponds to the horizontal.

14. The electronic device of claim 2, wherein the upper portion comprises a bending portion opposite to the first stopper and configured to prevent a swelling of the upper portion in the first direction.

15. The electronic device of claim 14, wherein the bending portion is faces the second direction.

16. A connector of an electronic device, comprising:
a base including a first face facing a first direction, a second face facing a second direction away from the first direction, and a side face including one side face and another side face perpendicularly facing the first and second directions, respectively;
a support member fixed to the base and facing the first face;
at least one first node fixed to a side of the base, and exposed on the first face;
at least one second node fixed to another side of the base, exposed on the first face, and provided between the at least one first node; and
a first stopper provided at a first portion of the support member and configured to lock the locking state of the FPCB contact.

17. The connector of claim 16, wherein the support member comprises:
an upper portion; and
an end bent from the upper portion and fixed to the side face,
wherein the first stopper is provided at the upper portion.

18. The connector of claim 17, wherein the first stopper comprises at least one stopping protrusion provided at the upper portion adjacent to the side face.

19. The connector of claim 18, wherein the at least one stopping protrusion faces the second direction by being bent at the upper portion.

20. The connector of claim 17, wherein the upper portion further comprises a bending portion opposite to the first stopper and configured to prevent a swelling of the upper portion in the first direction, and
wherein the bending portion faces the second direction.
